(19) United States
(12) Patent Application Publication
(10) Pub. No.: US 2009/0089677 A1
(43) Pub. Date: Apr. 2, 2009

(54) SYSTEMS AND METHODS FOR ENHANCED TEXTUAL PRESENTATION IN VIDEO CONTENT PRESENTATION ON PORTABLE DEVICES

(76) Inventor: Weng Chong "Peekay" Chan, Tigard, OR (US)

Correspondence Address: Duft Bornsen & Fishman, LLP, 1526 Spruce Street, Suite 302, Boulder, CO, 80302, US

(21) Appl. No.: 11/865,842

(22) Filed: Oct. 2, 2007

(51) Int. Cl. G06F 3/00

(52) U.S. Cl. 715/719

(57) ABSTRACT

Systems and methods for enhancing display of textual information in a video stream displayed on a portable device. In one aspect textual information is identified in frames of a video stream and is enhanced to improve visual readability of the textual information. The textual information may be enhanced by enlarging portions of frames of the video stream that include the textual information to overlay other portions of the display screen. The textual information may also be enhanced by converting the textual information in the frames of the video stream into character glyphs for display on the display screen of the portable device. Identification and enhancement of the textual information may be performed within the portable device or within systems external to the portable device and may be performed by automated procedures or responsive to user input on the portable device.

### BACKGROUND

1. Field of the Invention

The invention relates to video stream presentations on portable electronic devices and more specifically relates to systems and methods for enhancing the presentation of textual information included within video streams as presented on display screens of portable electronic devices.

2. Discussion of Related Art

Features and capabilities of portable electronic devices have increased at a frenzied pace. It is now common for portable devices such as music players, cell phones, personal digital assistants, etc., to provide a capability for presentation of video stream data. For example, modern music videos may be streamed directly to a portable device utilizing wired or wireless communication connections to permit a user to view a music video on demand on a portable device. Also, recorded television programs and/or movies (as well as live television broadcasts) may be streamed directly to portable devices for viewing by a user. Many forms of video stream content are now available for presentation on a portable electronic device.

It is common for portable electronic devices to provide relatively small display screens as compared to non-portable devices such as desktop computers and television/video display units. The relatively small size of the display screen in such portable electronic devices is a necessary tradeoff to maintain the desired level of portability.

Given the relatively small display screen size for most portable devices, it is sometimes a problem in video stream presentations to read textual information that is incorporated in the video presentation. For example, if the video stream presentation is a sporting event, scoring related information for the presented game as well as other scores for other sporting events may be temporarily displayed in portions of a sequence of frames of the video stream. The scoring information may be displayed persistently in a corner of the video stream presentation while the scores of other sporting events may appear temporarily in another portion of the display. If the video stream presentation has not been specifically designed for small display screens in portable devices, such textual information display may present a problem to users in that the textual information is too small to be easily read by a typical user. Often, smaller text in such a presentation may be shrunk to the size of merely a few pixels on the small display screen of a portable device such that individual characters are not even distinguishable.

It is therefore an ongoing challenge to provide adequate visual readability for textual information within a video stream presented on the small display screen of a portable device. In particular, it is a challenge to present practically readable textual information in the context of video stream presentations that have not been specifically designed for presentation on smaller display screens of portable electronic devices.

### SUMMARY

The present invention solves the above and other problems, thereby advancing the state of the useful arts, by providing systems and methods for enhancing the presentation of textual information within a video stream presentation on a display screen of a portable device. More specifically, features and aspects hereof include a method for presenting textual content in a video stream presented on a portable device. The method includes identifying a portion of a frame in the video stream that includes textual information. The identified portion comprises less than the entire frame. The method then includes enhancing the presentation of the identified portion to improve visual readability of the textual information on a display screen of the portable device. Other features and aspects hereof provide a method of presenting a video stream on a portable device. The method includes detecting textual information in the content of an initial video stream. The method then generates an altered video stream by enhancing the textual information in the initial video stream to improve visual readability of the textual information. The method then allows selective presentation of the initial video stream and/or the altered video stream for display on a display screen of a portable device.

### BRIEF DESCRIPTION OF THE DRAWINGS

FIG. 1 is a block diagram of an exemplary system in accordance with features and aspects hereof to enhance the presentation of textual information on display screens of portable devices.

FIG. 2 is a diagram depicting an exemplary display of a video stream in which textual information is identified in a portion of the display and enhanced in accordance with features and aspects hereof.

FIGS. 3 and 4 are block diagrams of exemplary systems in accordance with features and aspects hereof to enhance the presentation of textual information on display screens of portable devices.

FIG. 4 is a block diagram of one exemplary embodiment in which user input is received on the portable device to identify portions of the display screen including textual information to be enhanced.

FIGS. 5 through 7 are flowcharts describing exemplary methods in accordance with features and aspects hereof for identifying portions of a video stream display that include textual information and for enhancing the textual information so identified.

FIG. 8 is a block diagram of an exemplary portable device having a user input device for interacting with a user to identify textual information in portions of the display and for requesting enhancement of the identified portion in accordance with features and aspects hereof.

FIG. 9 is a flowchart describing an exemplary method in accordance with features and aspects hereof for identifying portions of a video stream display that include textual information and for enhancing the textual information so identified.

FIG. 10 is a block diagram depicting an exemplary enhancement of textual information on a display screen of a portable device in accordance with features and aspects hereof.

### DETAILED DESCRIPTION OF THE DRAWINGS

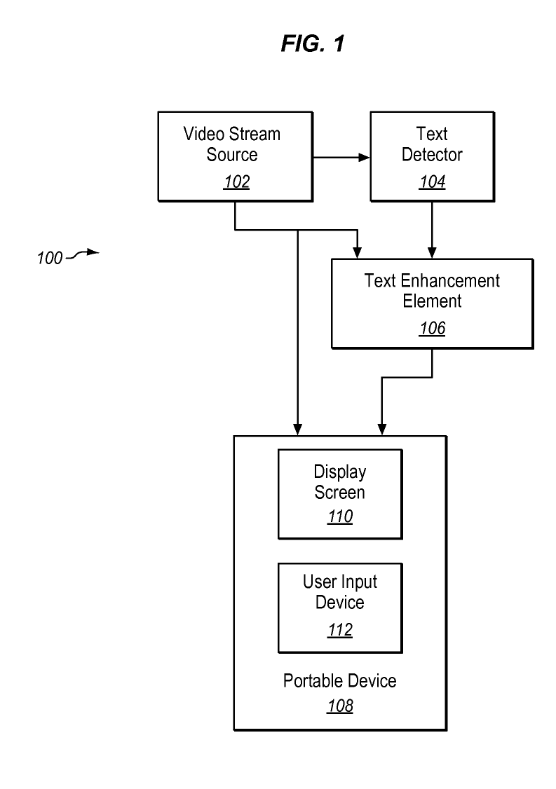

FIG. 1 is a block diagram of an exemplary system 100 in which a portable device 108 presents a video stream with enhanced textual information in accordance with features and aspects hereof. An initial video stream is produced by a video stream source 102 and provided to the portable device 108 for presentation on display screen 110 of portable device 108. In accordance with features and aspects hereof, a text detector element 104 may monitor the video stream from the video stream source 102 to detect the presence of textual information in one or more portions of frames of the video stream. Text detector 104 may then interact with text enhancement element 106 to enhance the presentation of the detected textual information. Text enhancement element 106 alters frames of the video stream for presentation by portable device 108 on its display screen 110. A user (not shown) of portable device 108 may interact through user input device 112 to instruct the portable device 108 the display the un-enhanced video stream or to enhance the display for the identified textual information.

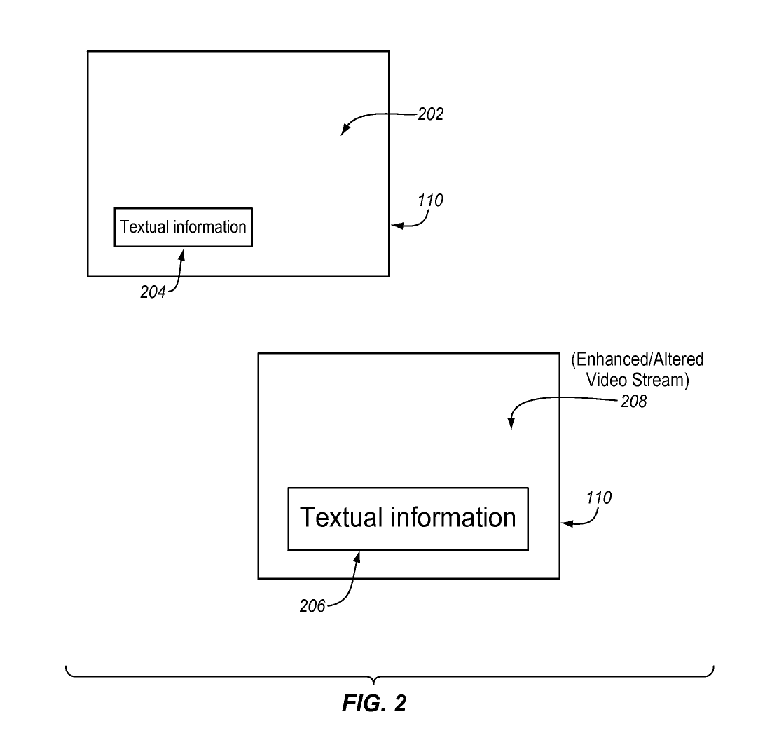

FIG. 2 is a block diagram of an exemplary enhancement of textual information in accordance with features and aspects hereof. At the top of FIG. 2, display screen 110 is shown to be presently displaying the content of an un-enhanced video stream 202. Within the video stream, textual information 204 is detected. A user may deem the textual information to be of poor visual readability (e.g., characters are too small on a small display screen 110 of a portable device 108). Alternatively, automated processing internal to the portable device 108 or external thereto may identify the textual information as needing enhancement. Such identified textual information may then be enhanced using system 100 of FIG. 1. The lower portion of FIG. 2 shows display screen 110 with an enhanced or altered video stream 208 displayed. Enhanced textual information 206 is displayed with improved visual readability. Details of the enhancement are discussed further below. In general, the shown enhancement represents either simple magnification or text recognition and conversion to utilize improved quality character code glyphs and spacing. The enhanced textual information provides improved visual readability as compared to the un-enhanced standard display of the video stream. The enhanced textual information 206 is displayed potentially overlaying other portions (un-enhanced portions) of the video stream display. The enhanced textual information 206 may be displayed for a predetermined period of time and/or until a user indicates that the display should revert to standard, un-enhanced display of the video stream.

As used herein, “visual readability” refers to the quality of the textual information as presented on the display screen. Factors that contribute to the readability of textual information include the size of the characters and the quality of the character representation (i.e., the quality of the representations of the characters by pixels on the display screen). Though no specific threshold for readability is implied by the phrase as used herein, it is the improvement of the readability to which the invention relates. By enhancing the textual information, the “visual readability” is improved.

As used herein, “enhancement” refers to operations including magnification or enlargement of the identified portions. Further, “enhancement” may also refer to conversion techniques such as text recognition to convert the textual information from pure image data in frames of the video stream to character codes. The converted character codes may then be used to generate corresponding font glyphs that improve the readability of the textual information. Examples of known text recognition methods include: EFFICIENT VIDEO TEXT RECOGNITION USING MULTIPLE FRAME INTEGRATION; by Hua, Xian-Sheng, et al. (Dept. of Computer Science and Technology, Tsinghua University) and FINDING TEXT IN IMAGES; by Wu, Victor, et al. (Center for Intelligent Information Retrieval, Computer Science Department, University of Massachusetts). Still further, in another form of “enhancement”, the converted character codes may be used to recognize the semantic of the textual information as, for example, a universal resource locator (URL) pointing at another source of information.

Referring again to FIG. 1, those of ordinary skill in the art will readily recognize that text detector element 104 and text enhancement element 106 may be operable as integral elements within portable device 108 or may be operable as elements external to the operation of portable device 108 (e.g., within an external server or system.). In addition, video stream source 102 may be embodied as an external server or system coupled to portable device 108 by any of several wired or wireless transmission media and associated communication protocols. Still further, video stream source 102 may also be integral with portable device 108 such as, for example, a previously stored video stream stored within a suitable storage medium associated with portable device 108.

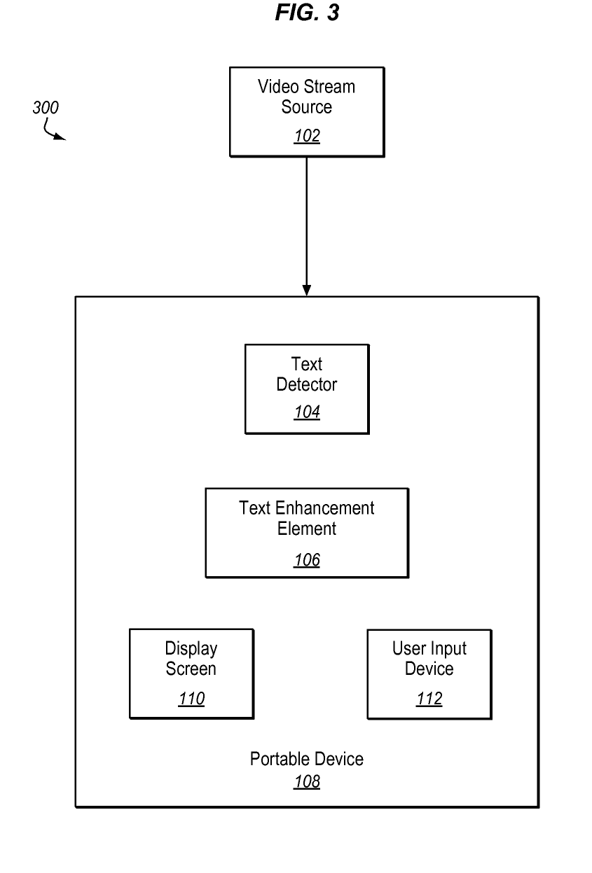

FIG. 3 shows an exemplary embodiment of a system 300 wherein portable device 108 includes text detector 104 and text enhancement element 106. Thus, portable device 108 receives a video stream from the video stream source 102 (by any suitable communication media and protocol). Processing features within the portable device 108 then detect textual information in need of enhancement and perform appropriate alteration of the video stream to enhance presentation of the detected textual information in the video stream.

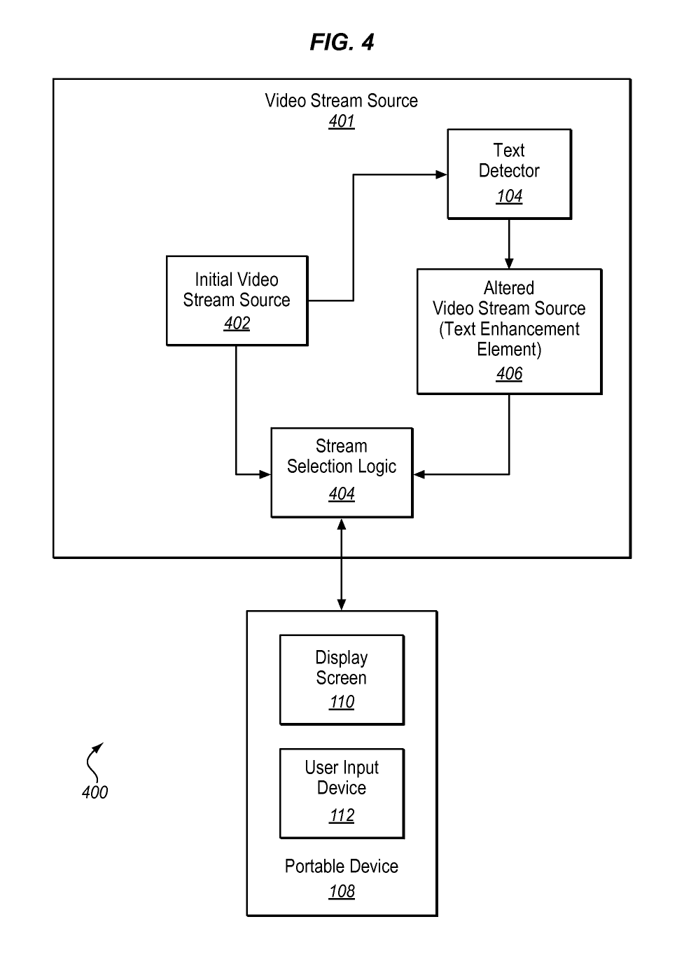

FIG. 4 shows another exemplary embodiment of a system 400 wherein an external video stream source 401 (external to the portable device 108) provides to the portable device 108 both an initial video stream from the initial video stream source 402 and the altered video stream (with enhanced textual information) from altered video stream source 406 (e.g., text enhancement element) through a stream selection logic element 404. Thus, a request from the portable device 108 to video stream source 401 dynamically selects between the unaltered initial video stream and the altered video stream that includes the enhanced textual information for presentation on the display screen of the portable device 108.

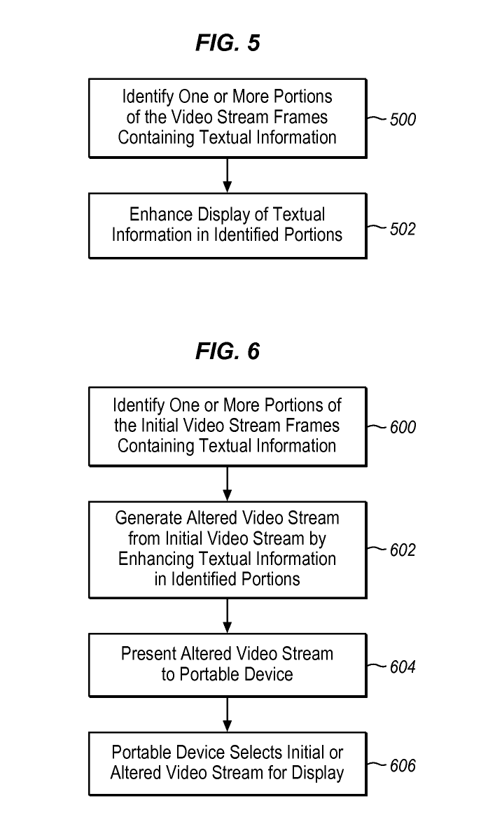

FIG. 5 is a flowchart describing an exemplary method in accordance with features and aspects hereof to permit a user of a portable device to selectively enhance display of textual information included within a video stream. The method of FIG. 5 generally represents processing within the portable device such as depicted in FIG. 3 to enhance display of textual information in a video stream provided to the portable device 108. Step 500 identifies one or more portions of the frames of the displayed video stream that include textual information. Step 500 may be performed as automated processing within the portable device that analyzes the graphical images of a sequence of frames to identify textual information in the video stream. The identified textual information may define a bounding box as a rectangular area that completely bounds the identified textual information—typically the minimum rectangular area that so contains the textual information. The bounding box of such identified textual information may then be mapped onto one or more portions of the display screen of the portable device to identify the display screen portions that include the identified textual information. In addition or in the alternative, the one or more portions of the frames of the video stream may be identified by user input on the portable device.

Step 502 then enhances the display of the textual information located in the identified portions of the screen and to selectively present the enhanced textual information overlaying the remainder of the video stream. The altered video stream with enhanced textual information may be selected for display responsive to user input on the portable device. In addition or in the alternative, the altered video stream with enhanced textual information may be automatically selected by the portable device when the identified textual information is present in the video stream for a first predetermined threshold of time. The altered stream may then be displayed for a second predetermined period of time to permit the user to read the enhanced textual content.

FIG. 6 is a flowchart representing another exemplary embodiment of a method in accordance with features and aspects hereof to enhance textual information identified in portions of the video stream. The method of FIG. 6 generally represents processing by a server or computing system (e.g., a streaming video server) external to the portable device such as shown in FIG. 4 above. The external server may alter the initial video stream to enhance identified portions of the display that include textual information. Step 600 identifies portions of the frames of an initial video stream that include textual information. The initial video stream is provided to the portable device by an initial video stream source—e.g., a server system external to the portable device. Step 602 then generates an altered video stream from the initial video stream by enhancing textual information found within identified portions of the initial video stream. Step 604 presents the altered video stream to the portable device. Step 606 represents processing to select either the initial video stream or the altered video stream for display on the portable device. Selection means within the portable device or external to the portable device may respond to user input such as a keystroke, voice command, touch screen actuation, or other well-known user interaction to select either the initial video stream or the altered video stream for current presentation on the portable device. Thus the altered video stream may be continually or selectively generated in parallel with the initial video stream and both made available for selective display on the portable device. Further, as discussed above, the altered video stream may be manually selected for display by user input from the portable device or may be automatically selected when the identified textual information is present in the video stream for a first predetermined threshold of time. The altered stream may then be displayed for a second predetermined period of time to permit the user to read the enhanced textual content.

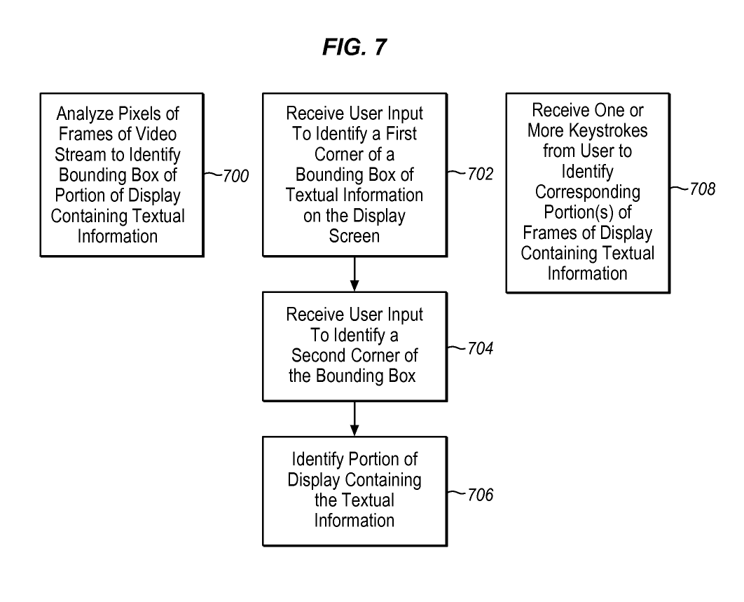

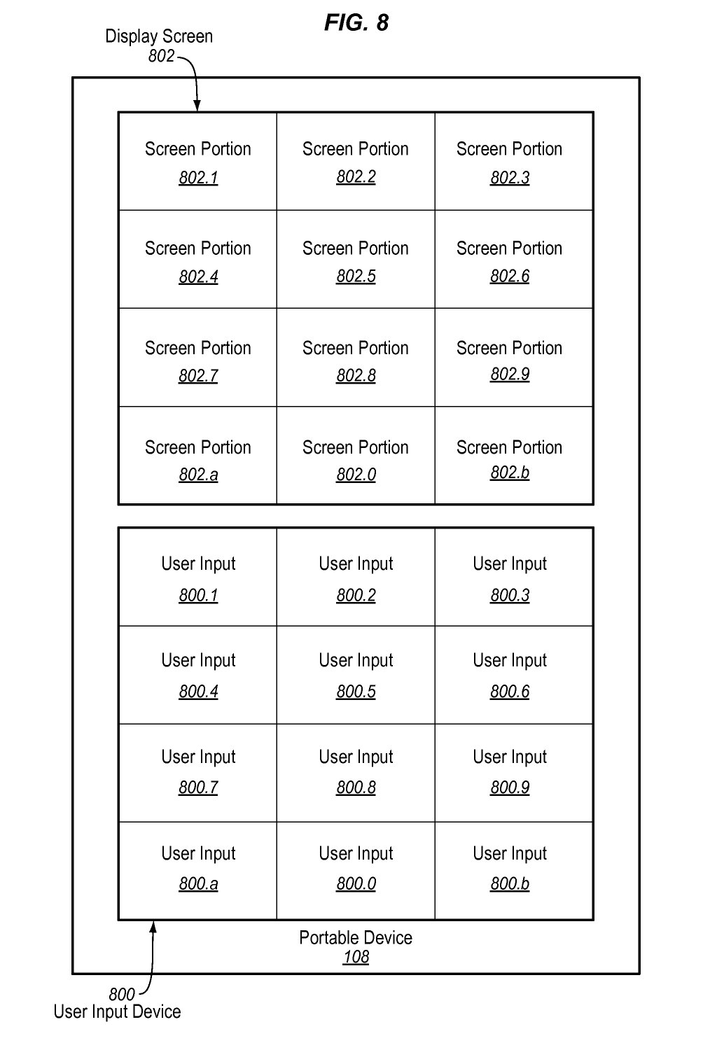

Identification of portions of the frames of the video stream including textual information (such as steps 500 and 600 of FIGS. 5 and 6, respectively) may be performed in accordance with any of various techniques. FIG. 7 provides flowcharts of three exemplary approaches to identifying a portion or portions of the video stream that include textual information that may be enhanced. Any or all of these three methods, as well as other equivalent methods, may be employed in a system according to features and aspects hereof. Processing for the methods of FIG. 7 may be performed within the portable device or may be performed in server systems external to the portable device.

Step 700 represents any of numerous well-known automated, graphical analysis techniques to identify a portion of frames of the video stream that may include textual information. Step 700 represents graphical analysis of pixels in the frames of the video stream (e.g., edge detection and/or text recognition techniques) to identify a bounding box of textual information in the video stream. Generally such a bounding box may be determined by analyzing a sequence of frames to locate likely textual information as unchanged portions of the frames of the video stream.

Steps 702 through 706 represent another exemplary method for identifying a portion of the display screen on the portable device including textual information that may be enhanced. Step 702 first receives user input identifying a first corner of a bounding box. Step 704 receives user input to identify a second corner of the bounding box (diagonally opposite the first corner). Such user input may be provided, for example, by a pointer device associated with the portable device or by touch screen features integrated with the display screen of the portable device. As is generally known, the second corner may be located by user input “stretching” a box from the first corner. Step 706 then identifies the portion of the screen as defined by the bounding box on the display screen of the portable device established by the corners located by user input.

Step 708 represents another exemplary method for identifying a plurality of adjacent portions of the display screen that in combination represent the portion that may be enhanced. Keys (e.g., switches or sensors) on the portable device may be logically mapped to corresponding portions of the display screen of the portable device. Thus step 708 receives one or more keystrokes from the user (user input) to identify corresponding adjacent portions of the display screen that include textual information that may be enhanced. In addition to automated operation, detection of portions of the frames of the video stream including textual information may be performed in accordance with user input from the portable device 108.

FIG. 8 is a block diagram suggesting one exemplary embodiment of a portable device 108 on which one or more user input key activations identify one or more portions of the video stream that include textual information to be enhanced (such as may be used by the method of step 708 of FIG. 7). In the exemplary embodiment of FIG. 8, portable device 108 includes a user input device 800 comprising a matrix of switches or sensors 800.0 through 800.b. Each switch or sensor is representative of a corresponding portion of display screen 802 of portable device 108. Thus display screen 802 is logically divided into corresponding portions 802.0 through 802.b. A user of portable device 108 views the video stream as presented on display screen 802 and determines portions (802.0 through 802.b) of the display screen 802 that include textual information the user wishes to enhance. The user then actuates one or more corresponding switches or sensors 800.0 through 800.b of user input device 800 to indicate the particular portions that include the textual information to be enhanced. Where the bounding box of the textual information to be enhanced is completely contained within a single portion 802.0 through 802.b of display screen 802, the user need activate only a single switch or sensor 800.0 through 800.b of input device 800. Where the textual information spans multiple (typically adjacent) portions of display screen 802, the user may activate multiple adjacent switches or sensors on input device 800.

Thus FIG. 8 represents one exemplary embodiment of a user interacting with the portable device 108 through a user input device 800 to identify portions of the display screen 802 that include textual information to be enhanced. User input switches or sensors (e.g., keys) 800.0 through 800.b may be implemented as any of a variety of well-known switch or sensor components. For example, mechanical, membrane, capacitive sense switches, etc. laid out as a typical telephonic keypad on a cellular telephone may be used to identify corresponding portions 802.0 through 802.b of display screen 802. Still further, for example, user input device 800 may be implemented as virtual keys on a touch screen integrated with the display screen 802. A user may simply point to areas of the screen, touching one or more portions of the screen as “key strokes”, to identify corresponding portions that include textual information to be enhanced. Still further, user input device 800 may be implemented as voice recognition capability within portable device 108 such that the user may identify, as virtual key strokes using voice command, portions of the display screen 802 that include textual information to be enhanced. Thus, FIG. 8 is intended merely as representative of one exemplary embodiment of a user input device and its use to identify one or more portions of the screen that include textual information in the video stream on the display screen of the portable device.

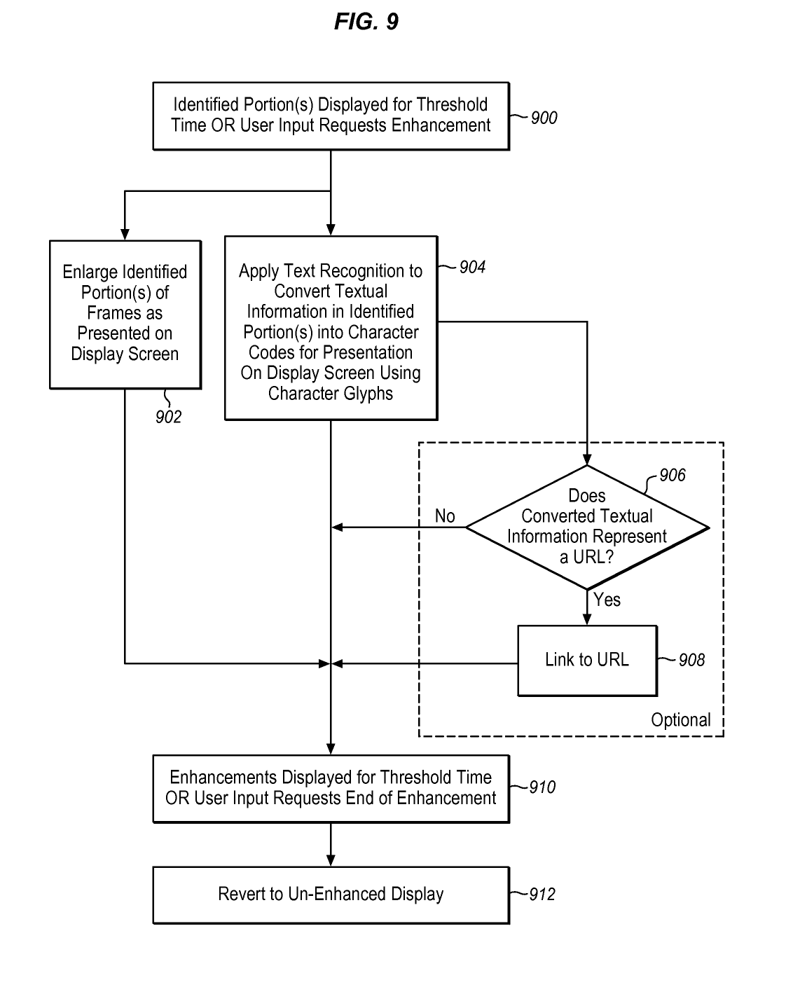

Having identified one or more portions of the video stream that include textual information, FIG. 9 is a flowchart of exemplary methods for performing the enhancement (such as steps 502 and 602 of FIGS. 5 and 6, respectively). In general, enhancement of identified portions may occur automatically if the identified portion is displayed for a sufficient threshold period of time. In addition or in the alternative, enhancement may be specifically requested by user input (e.g., key strokes, voice command, etc.). To actually enhance the textual information the identified portions may be simply magnified or enlarged or may be converted to higher quality (and typically larger) font glyphs. The enhanced textual information may then be displayed, overlaying other portions of the display of the video stream, for a predetermined threshold period of time or until user input directs reversion of the display to the un-enhanced video stream display.

Step 900 initiates enhancement of the identified portion or portions that include textual information in response to either a predetermined threshold period of time or in response to user input requesting enhancement. Either of two enhancement methods may then be applied. Step 902 is a first method to enlarge or magnify the identified portions of frames of the video stream as presented on the display screen. The enlarged or magnified portions of the images of frames in the video stream display will render the textual information contained in those portions more readable by virtue of its size. The entire identified portion or portions of the display screen will be enlarged such that the textual information and any other graphical information content in those portions will be improved as regards visual readability. In some cases, a portable device may have built in font images (i.e., character code glyph images) that may be still more visually readable than even the magnified image of portions that include textual information. Step 904 represents application of a second method applying well-known text recognition techniques to convert the textual information in the identified portion or portions of the display screen into corresponding character codes for enhanced display on the portable device. The character codes are then mapped to corresponding character glyphs (within the portable device or downloaded to the portable device) for enhanced display of the identified portions of the video stream that include textual information.

As a further optional enhancement, where text recognition techniques are applied by step 904, an optional evaluation of the converted textual information may be performed by step 906 to determine whether the textual information represents a URL of another source of data to be presented. If this optional test is performed but the textual information is not recognized as a URL, processing continues with step 910. If step 906 determines that the converted textual information likely represents a URL, step 908 causes the portable device to link to the identified URL to thereby alter the presentation of data on display screen of the portable device. Thus, a user of the portable device may in effect browse or navigate through links found in a video stream presentation. For example, a video stream of a sporting event may include textual information representing a URL at which additional details may be available for the subject being discussed (e.g., additional player or team statistics). Or, for example, a video stream may include an advertisement in which a URL points to the vendor's web site with further product or company information. Any of several well-known user interaction techniques including, for example, key switches of the portable device, touch screens on a portable device, voice command recognition on the portable device, etc. may be employed to identify a URL in the video stream textual information and for selecting the option to link to the URL content.

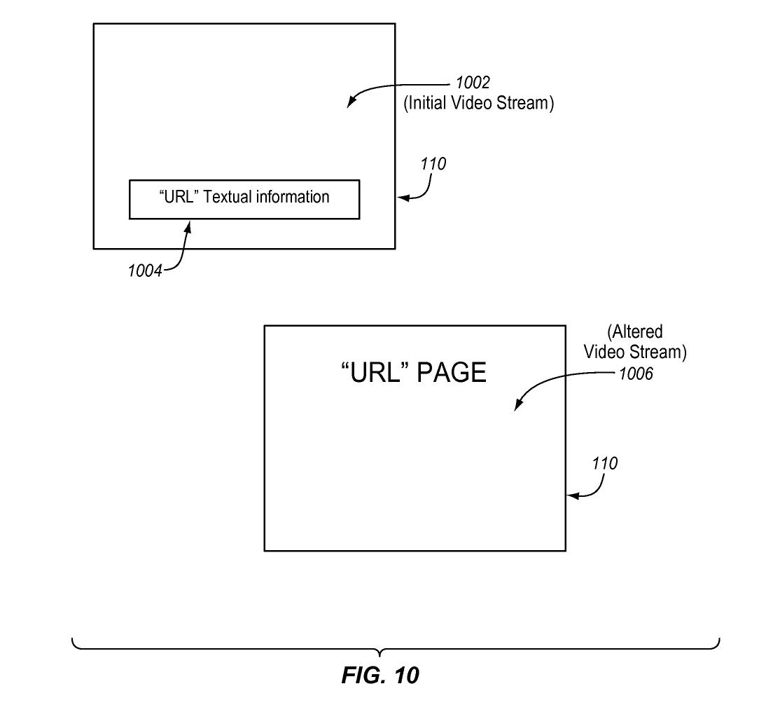

FIG. 10 shows an exemplary enhancement of textual information in accordance with features and aspects hereof where the method of FIG. 9 determines that the textual information represents a URL. In the upper portion of FIG. 10, display screen 110 is shown as presently presenting an initial video stream 1002. A portion of the initial video stream 1002 is identified to include textual information 1004. Further, by use of text recognition techniques as discussed above in FIG. 9, it is determined that the text represents a URL of another resource. Either automatically or through appropriate interaction with a user the textual information 1004 representing a new URL may be “linked to” resulting in the display in the lower half of FIG. 10 with display screen 110 now presenting an altered video stream 1006 (or other content) corresponding to the new “URL” page.

The apparatus, systems, and methods of FIGS. 1 and 3-10 are intended merely as exemplary of possible embodiments of features and aspects hereof. Numerous additional and equivalent steps and components will be readily apparent to those of ordinary skill in the art and are omitted from this discussion for simplicity and brevity.

Those of ordinary skill in the art will readily recognize an infinite variety of video stream displays that may incorporate textual information for which a user may desire temporary enhancement to improve visual readability. FIGS. 2 and 11 are therefore intended merely as exemplary forms of textual information enhancement in accordance with features and aspects hereof.

While the invention has been illustrated and described in the drawings and foregoing description, such illustration and description is to be considered as exemplary and not restrictive in character. Various embodiments of the invention and minor variants thereof have been shown and described. In particular, those of ordinary skill in the art will readily recognize that exemplary methods discussed above may be implemented as suitably programmed instructions executed by a general or special purpose programmable processor or may be implemented as equivalent custom logic circuits including combinatorial and/or sequential logic elements. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for presenting textual content in a video stream presented on a portable device, the method comprising:
identifying a portion of a frame in the video stream that includes textual information wherein the portion comprises less than the entire frame; and
enhancing the presentation of the identified portion to improve visual readability of the textual information on a display screen of the portable device.

2. The method of claim 1 wherein the step of identifying further comprises receiving user input to identify the portion of the frame.

3. The method of claim 2 further comprising:
logically dividing the display screen into a plurality of predefined portions,
wherein the step of receiving user input further comprises receiving user input identifying said portion as a selected portion of the plurality of predefined portions.

4. The method of claim 3 wherein the portable device presents a user with a keypad having a plurality of keys and wherein each key corresponds to one of the plurality of predefined portions,
wherein the step of receiving user input further comprises receiving user input comprising actuating a key of the keypad to select a corresponding selected portion of the display screen.

5. The method of claim 4 wherein the step of receiving user input further comprises receiving user input comprising actuating multiple keys of the keypad to select corresponding selected portions of the display screen.

6. The method of claim 1 wherein the step of enhancing further comprises enlarging the identified portion that includes the textual information to improve visual readability of the textual information.

7. The method of claim 1 wherein the step of enhancing further comprises converting the textual information in the identified portion into corresponding character glyphs for presentation on the display screen to improve visual readability of the textual information.

8. The method of claim 1 wherein the step of enhancing further comprises:
recognizing that the textual information represents a universal resource locator (URL); and
linking to the URL to present the content of the URL on the portable device.

9. A portable electronic device adapted to present a video stream, the portable device comprising:
a display screen for displaying the video stream; and
a text enhancement element adapted to identify a portion of a frame of the video stream that includes textual information wherein the portion is less than the entire frame and further adapted to enhance the display of the portion to improve visual readability of the textual information.

10. The device of claim 9 further comprising:
a user input device for receiving user input,
wherein the enhancement element is further adapted to identify the portion responsive to the user input.

11. The device of claim 10 wherein the user input device is a keypad comprising a matrix of switches.

12. The device of claim 11
wherein the enhancement element is further adapted to logically divide the display screen into a plurality of predefined portions,
wherein the enhancement element is further adapted to associate a unique key of the keypad with each of the plurality of predefined portions,
wherein the enhancement element is further adapted to receive user input from the keypad identifying said portion as a selected portion of the plurality of predefined portions corresponding to the associated key being activated.

13. The device of claim 10 wherein the user input device is a touch screen integrated with the display screen.

14. A method of presenting a video stream on a portable device, the method comprising:
detecting textual information in the content of an initial video stream;
generating an altered video stream by enhancing the textual information in the initial video stream to improve visual readability of the textual information; and
selectively presenting the initial video stream and/or the altered video stream for display on a display screen of a portable device.

15. The method of claim 14 wherein the step of generating further comprises:
enhancing the textual information by enlarging a portion of one or more frames of the altered video stream that includes the textual information to improve visual readability of the textual information wherein the portion comprises less than the entirety of any frame.

16. The method of claim 14 wherein the step of generating further comprises:
enhancing the textual information by converting the textual information in a portion of one or more frames of the altered video stream into corresponding character glyphs for presentation on the display screen to improve visual readability of the textual information wherein the portion comprises less than the entirety of any frame.

17. The method of claim 14 wherein the step of detecting further comprises:
logically dividing the display screen into a plurality of predefined portions; and
determining which of the predefined portions includes textual information.

18. The method of claim 14 further comprising:
receiving user input on the portable device requesting presentation of the altered video stream,
wherein the steps of detecting, generating, and selectively presenting are responsive to the reception of the user input requesting presentation of the altered video stream.

19. A system for presentation of a video stream, the system comprising:
an initial video stream source adapted to generate an initial video stream;
a text detector coupled to receive the initial video stream and adapted to detect textual information in a portion of one or more frames of the initial video stream;
an altered video stream source coupled to receive the initial video stream and coupled to the text detector and adapted to generate an altered video stream by enhancing the visual readability of the textual information detected in the initial video stream by the text detector; and
a portable device having a display screen coupled to selectively present to a user either the initial video stream or the altered video stream on the display screen.

20. The system of claim 19 wherein the text detector and the altered video stream source are integral within the portable device.

21. The system of claim 19 wherein the text detector and the altered video source are external to the portable device.

22. The system of claim 19 wherein the portable device further comprises:
a user input device for receiving user input from the user where the user input includes a user request to select the initial video stream or to select the altered video stream for presentation on the display screen.

23. The system of claim 22 wherein the user input further includes indicia of portions of the display screen that include the textual information to be enhanced by the altered video stream source in generating the altered video stream.
